(19) United States
(12) Patent Application Publication
(10) Pub. No.: US 2019/0017239 A1
(43) Pub. Date: Jan. 17, 2019

(54) ENVIRONMENTAL BARRIER DEVICES, SYSTEMS, AND METHODS

(71) Applicant: Tidy Site Services, LLC, Waukee, IA (US)

(72) Inventor: Reid Tamisiea, Waukee, IA (US)

(21) Appl. No.: 15/647,436

(22) Filed: Jul. 12, 2017

(51) Int. Cl. E02B 3/04; E02D 29/02; F16B 5/00

(52) U.S. Cl. CPC E02B 3/04; F16B 5/0004; E02D 29/02

(57) ABSTRACT

Environmental barrier devices, systems, and methods are disclosed herein. One environmental barrier system includes a first plate, a second plate, and a fastener configured to fasten the first plate to the second plate. Each of the plates has a front surface, a rear surface, an apertured portion, and a base portion. The apertured portion includes an apertured portion width and defines a plurality of apertures through the front and rear surfaces. The base portion includes a base portion width that tapers to become narrower than the apertured portion width. The first and second plates are configured to be positioned next to one another such that the base portions are buried below ground and the apertured portions extend above the ground substantially vertically.

### TECHNICAL FIELD

This disclosure relates generally to devices, systems, and methods for environmental barriers, for instance, to control erosion.

### BACKGROUND

Surface runoff, often referred to as erosion, can be a common problem. Causes of erosion can be natural or man-made. Natural erosion can be caused by wind, rainfall, flooding, or other geological forces. Man-made erosion can result from human initiated disturbances to land topography, such as may be common at or near construction sites. In any case, if left uncontrolled, erosion can lead to detrimental, and in some instances dangerous, situations.

Accordingly, erosion control techniques may be necessary to prevent and/or react to surface runoff conditions that have the potential to lead to detrimental situations. A number of different techniques can be used to control erosion depending on the severity of the condition. One technique is to deploy an obstruction that acts to block surface runoff. However, these obstructions often lack the structural design and integrity needed to withstand, and be effective in, applications experiencing relatively strong forces. Moreover, these obstructions can be unsuitable for certain terrain conditions and/or installation techniques.

### SUMMARY

This disclosure in general describes environmental barrier devices, systems, and methods that can be used, in one example, for erosion control. The environmental barrier embodiments disclosed herein can be suitable for use in a variety of applications, including those requiring the environmental barrier to withstand relatively large static and/or dynamic forces. The environmental barrier embodiments disclosed herein can also have one or more features allowing for deployment in a wide range of terrains. In addition, these environmental barrier embodiments may include one or more features to facilitate installation using efficient techniques appropriate for barriers of high structural integrity.

In one exemplary embodiment, an environmental barrier system includes a first plate, a second plate, and a fastener configured to fasten the first plate to the second plate. Each of the plates has a front surface, a rear surface, an apertured portion, and a base portion. The apertured portion includes an apertured portion width and defines a plurality of apertures through the front and rear surfaces. The base portion includes a base portion width that tapers to become narrower than the apertured portion width. The first and second plates are configured to be positioned next to one another such that the base portions are buried below ground and the apertured portions extend above ground substantially vertically.

Embodiments also include methods for impeding a flow of water. In an exemplary embodiment, a method of impeding a flow of water includes providing a first plate and a second plate. Each provided plate has a front surface, a rear surface, an apertured portion, and a base portion. The apertured portion has an apertured portion width and defines a plurality of apertures through the front and rear surfaces. The base portion has a base portion width that tapers to become narrower than the apertured portion width. This embodiment of the method further includes positioning the first and second plates next to one another by burying the base portions of the first and second plates below ground such that the apertured portions extend above ground substantially vertically. In addition, this embodiment of the method includes fastening the first plate to the second plate with a fastener.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular examples of the present invention and therefore do not limit the scope of the invention. The drawings are not to scale (unless so stated) and are intended for use in conjunction with the explanations in the following detailed description. Examples of the present invention will hereinafter be described in conjunction with the appended drawings.

FIG. 1 is a front elevational view of an embodiment of a plate, along with a filter sheet in contact with the plate, for use in an environmental barrier system.

FIG. 2 is a side elevational view of the plate and filter sheet in FIG. 1.

FIG. 3 is a front elevational view of an embodiment of an environmental barrier system.

FIG. 4 is a rear elevational view of another embodiment of an environmental barrier system.

FIG. 5 is a flow diagram of an embodiment of a method for impeding a flow of water.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

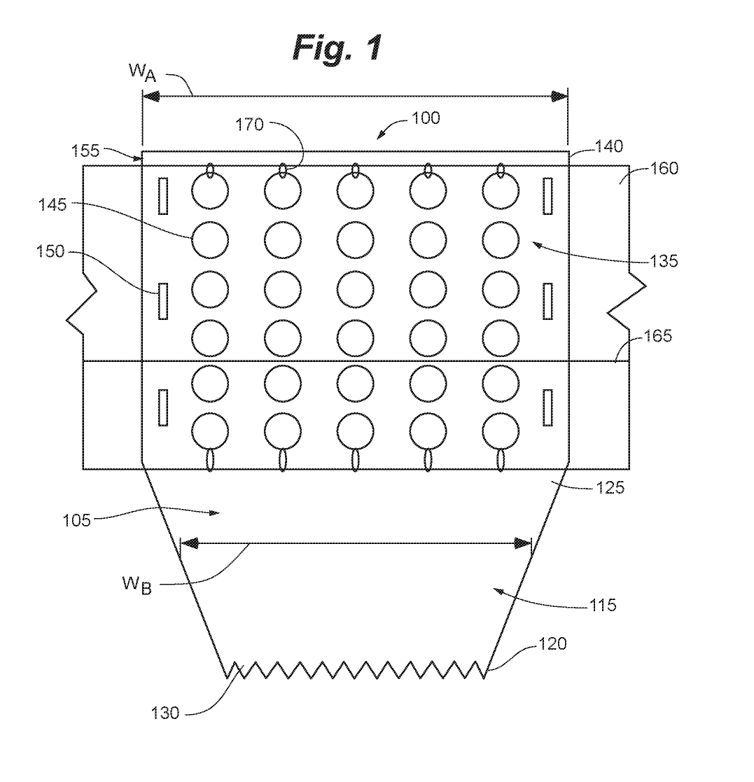

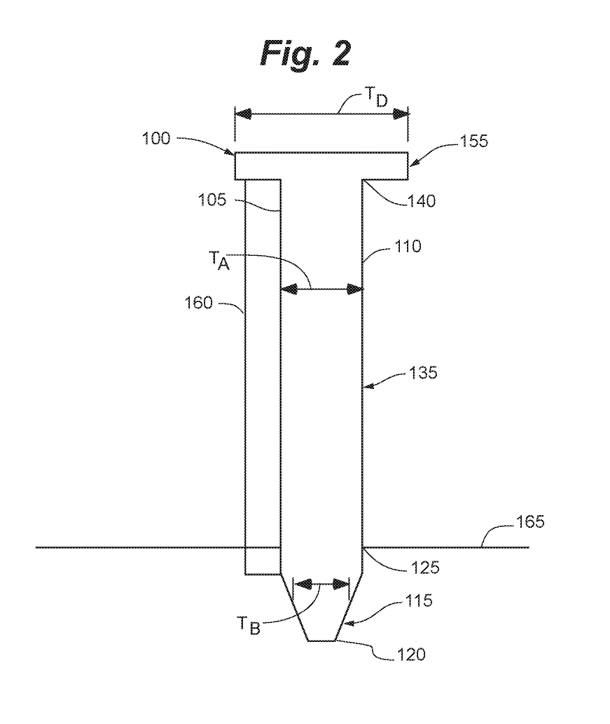

FIGS. 1 and 2 illustrate an embodiment of a plate 100 along with an embodiment of a filter sheet 160. FIG. 1 shows a front elevational view, while FIG. 2 shows a side elevational view of the plate 100 and filter sheet 160. For ease of illustrating various features of the plate 100, the filter sheet 160 is shown in FIG. 1 as transparent. As will be described further below, the plate 100, and in some examples the filter sheet 160, can be used, for instance, as a component in an environmental barrier system. But, before describing further examples of an environmental barrier system, details of the plate 100 are first discussed.

The exemplary plate 100 shown in FIGS. 1 and 2 defines a front surface 105 and a rear surface 110. The front surface 105 and the rear surface 110 can be surfaces that are generally opposite one another and act to define a thickness of the plate 100 therebetween. Although each of the front and rear surfaces 105, 110 are shown are continuous surfaces in the illustrated example, in other examples the front and rear surfaces 105, 110 need not be continuous surfaces and may, in some cases, be made up of a variety of distinct geometric features.

The illustrated plate 100 further includes a base portion 115. The base portion 115 can be bounded by a base lower edge 120 on a first end and a base upper edge 125 on a second, generally opposite end. The lower edge 120 includes, in the present embodiment, a plurality of pointed segments 130 along at least a portion of the length of the lower edge 120. The pointed segments 130 can be configured to provide a structure on the plate 100 useful for breaking through ground terrain (e.g., stone or other rough ground terrain) when installing the plate 100, such as by driving the lower edge 120 of the base portion 115 into the ground.

The base portion 115 can define a base portion width W_{B} and a base portion thickness T_{B}. As shown in the example of FIG. 1, the base portion width W_{B} is nonuniform. The base portion width W_{B} may be defined at any base portion 115 location between opposing side surfaces of the plate 100. In this example, the base portion width W_{B} in nonuniform in that it tapers to become narrower in a direction moving from the base upper edge 125 to the base lower edge 120. Thus, in this one example, the base lower edge 120 has the smallest width along the base portion 115. As shown in the example of FIG. 2, the base portion thickness T_{B} is also nonuniform. The base portion thickness T_{B} may be defined at any base portion 115 location between the front surface 105 and the rear surface 110. In this example, the base portion thickness T_{B} is nonuniform in that it tapers to become narrower in a direction moving from the base upper edge 125 to the base lower edge 120. Thus, in this one example, the base lower edge 120 has the smallest thickness along the base portion 115.

Embodiments of the plate 100 including the disclosed nonuniform (e.g., tapered) base portion width W_{B} and/or nonuniform (e.g., tapered) base portion thickness T_{B} can be useful in promoting installation of the plate 100. For instance, in the illustrated example the plate 100 can transfer the installation force imparted onto the plate 100 to the ground at a reduced surface area thereby allowing the plate 100 to be more easily installed in particular ground terrain.

The exemplary plate 100 additionally includes an apertured portion 135. The apertured portion 135 can be bounded by the base upper edge 125 on a first end and an aperture upper edge 140 on a second, generally opposite end. In the illustrated example, the apertured portion 135 defines a plurality of apertures 145 extending through the plate 100 from the front surface 105 to the rear surface 110. In various examples, the number of apertures 145 defined at the apertured portion 135 can vary from one to a plurality (e.g., ten, twenty, thirty, etc.). In some embodiments, the apertures 145 can each be the same, or similar, in size and shape. In other embodiments, the apertures 145 can include a first set one or more apertures of a first size and shape and a second set of one or more apertures of a second size and shape, where the size and/or shape of the first set of apertures differs from that of the second set of apertures. Where the apertured portion 135 includes apertures 145 stacked along a height (e.g., dimension perpendicular to width) of the apertured portion, fluid can be allowed to pass through the plate without building up at the plate. This can be useful where surface runoff material is collected along a segment of the height of the apertured portion, since fluid can then still pass through higher apertures 145. As such, unsuitable hydrostatic forces on the plate 100 may be prevented.

In the embodiment of the plate 100 that is shown, the apertured portion 135 further defines a number of fastening apertures 150 extending through the plate 100 from the front surface 105 to the rear surface 110. In embodiments (such as the one shown) including both apertures 145 and fastening apertures 150, the apertures 145 can be configured to serve a different function than the fastening apertures 150. For instance, the apertures 145 may be configured (e.g., numbered, sized, shaped, positioned) to allow a desired amount of fluid to pass through the plate 100 while the fastening apertures 150 may be configured (e.g., numbered, sized, shaped, positioned) to receive one or more fasteners useful in installing the plate 100 in connection with an adjacent plate. In some cases, the apertures 145 may be configured to allow a relatively large volume of fluid to pass through the plate 100, and the fastening apertures 150 may be configured receive one or more fasteners suited for withstanding relatively large forces.

The apertured portion 135 can also define an apertured portion width W_{A} and an apertured portion thickness T_{A}. As shown in the example of FIG. 1, the apertured portion width W_{A} is uniform. The apertured portion width W_{A} may be defined at any apertured portion 135 location between opposing side surfaces of the plate 100. Accordingly, in the illustrated example, the base portion width W_{B} is substantially equal to the apertured portion width W_{A} at the base upper edge 125. But, the base portion width W_{B} tapers to become narrower than the apertured portion width W_{A} at locations along the base portion 115 moving in a direction from the base upper edge 125 toward the base lower edge 120. As shown in the example of FIG. 2, the apertured portion thickness T_{A} is uniform. The apertured portion thickness T_{A} may be defined at any apertured portion location between the front surface 105 and the rear surface 110. Accordingly, in the illustrated example, the base portion thickness T_{B} is substantially equal to the apertured portion thickness T_{A} at the base upper edge 125. But, the base portion thickness T_{B} tapers to become less than the apertured portion thickness T_{A} at locations along the base portion 115 moving in a direction from the base upper edge 125 toward the base lower edge 120.

Certain embodiments of the plate 100 may further include a drive head 155. The drive head 155 can be adjacent the aperture upper edge 140. The drive head 155 defines a drive head thickness T_{D}. As shown in the example of FIG. 2, the drive head thickness T_{D} is uniform but in other embodiments the drive head thickness T_{D} can be nonuniform (e.g., taper in a direction toward the aperture upper edge 140). As also shown in this example, the drive head thickness T_{D} is greater than the apertured portion thickness T_{A}.

In one embodiment, the drive head 155 may be configured to receive a downward force applied by a mechanical device. For instance, the drive head 155 can be configured to receive a downward force applied by a general purpose moving machine, such as a movable bucket of the general purpose moving machine. In this embodiment, the plate 100 is then configured to be driven into the ground by a general purpose moving machine (e.g., a movable bucket of the general purpose moving machine) applying a downward force on the drive head 155. Therefore, according to this embodiment, the plate 100 can be installed without the need for specially suited machinery (useful, e.g., in situations on short notice).

The plate 100 can be formed of one or more materials. In one example, the plate 100 is formed of a metal material. The particular metal material in such an example can vary depending on the application in which the plate 100 is to be used. In one instance, the metal material can be selected from among metal materials appropriate for withstanding a wide range of static and dynamic forces. The metal material may also be selected as suitable for reuse of the plate. Such a metal material can include, for instance, steel. In other examples, the plate 100 can be formed of any other suitable material, including high strength polymer materials. In some cases, the plate 100 may be a composite structure formed from a combination of metal materials, polymer materials, and/or combinations thereof.

Also illustrated in the examples of FIGS. 1 and 2 is a filter sheet 160 positioned in contact with the plate 100. Here, the plate 100 is installed with the base portion 115 buried below ground 165 and at least a portion of the apertured portion 135 extending (e.g., substantially vertically) above ground 165. As shown in the example here, some of the aperture portion 135 can be buried below ground 165. The filter sheet 160 can be made, for instance, of a fluid permeable fabric material, and thus include sieves, or other openings, large enough to allow for fluid to pass but small enough to prevent sediments, soil, or other solid particulates from passing. The filter sheet 160 can be configured to be positioned against the plate's apertured portion 135 and in some cases at least a portion of the plate's base portion 115. As shown, the filter sheet 160 is positioned in contact with the apertured portion 135 at the front surface 105, but in another example the filter sheet 160 can be positioned in contact with the apertured portion 135 at the rear surface 110. The filter sheet 160 can extend up a distance from the ground 165 (e.g., one foot, two feet, three feet, etc.) while in contact with the plate's aperture portion 135. In one example, the filter sheet 160 can be secured to the plate 100, for instance at the apertures 145 and/or the fastening apertures 150, via a securing element 170 (e.g., a band, tie, etc.), such as along the top and/or bottom portion of the filter sheet 160. In some examples, after the filter sheet 160 is secured to the plate 100, ground 165 can be backfilled such that a portion of the filter sheet 160 is below ground 165. This may be useful to further keep the filter sheet 160 in place at the plate 100.

In this way, by positioning the filter sheet 160 relative to the plate 100 erosion can be controlled since the filter sheet 160 can act to impede the passage of surface runoff entrained in fluid flow while the apertured portion 135 of the plate 100 can allow fluid to pass through the plate 100. In some cases, however, the apertured portion 135 can be configured (e.g., the apertures thereof sized) such that the filter sheet 160 is not needed to impede the passage of surface runoff entrained in fluid flow.

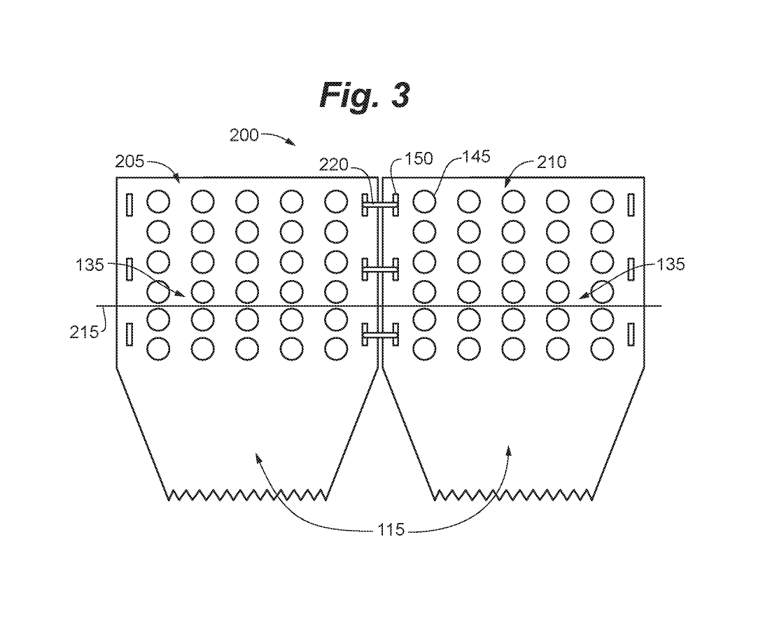

FIG. 3 illustrates a front elevational view of an embodiment of an environmental barrier system 200. The environmental barrier system 200 includes a first plate 205 and a second plate 210. In this example, each of the first plate 205 and the second plate 210 can include any one or more of the details disclosed herein with respect to the plate 100.

The first and second plates 205, 210 may be configured to be positioned next to one another as shown in the present example. Each of the first and second plates 205, 210 in the system 200 can have the base portion 115 buried below ground 215 and the apertured portion 135 extending above ground 215 (e.g., substantially vertically as shown). In this way, the length of ground along which a barrier is established is extended. Additional plates (e.g., a third plate) can be installed similarly next to the first plate 205 and/or the second plate 210.

The environmental barrier system 200 can further include one or more fasteners 220. Each fastener 220 may be configured to fasten the first plate 205 to the second plate 210 when the plates 205, 210 are positioned next to one another. The illustrated example shows a number of fasteners 220, although in one example a single fastener 220 can be used. The fastener 220 in some embodiments can be in the form of a strap, tie, or other joining structure. In one embodiment, each fastener 220 is configured to be inserted into an aperture 145 of the first plate 205 and into an aperture 145 of the second plate 210 to fasten the first plate 205 to the second plate 210. In some cases, such as the embodiment illustrated in FIG. 3, each of the plates 205, 210 may include a fastening aperture 150 particularly configured to receive a fastener 220. In such embodiment, each fastener 220 is configured to be inserted into a fastening aperture 150 of the first plate 205 and into a fastening aperture 150 of the second plate 210 to fasten the first plate 205 to the second plate 210. As noted previously, this type of embodiment can allow apertures 145 to be configured to serve a different function than the fastening apertures 150. Here, the apertures 145 may be configured to allow a desired amount of fluid to pass through the plates 205, 210 while the fastening apertures 150 may be configured to receive fasteners 220 in a manner that is suited for withstanding relatively large forces imparted on the fasteners 220.

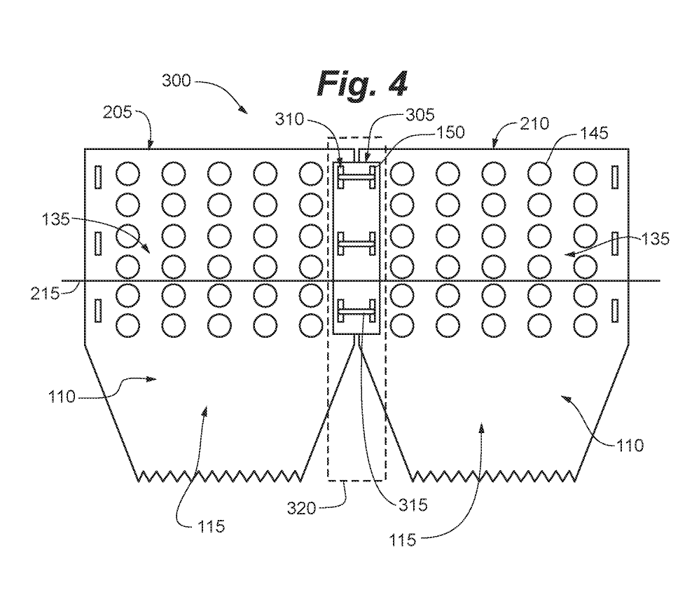

FIG. 4 illustrates a rear elevational view of another embodiment of an environmental barrier system 300. The environmental barrier system 300 illustrated in FIG. 4 is similar to the environmental barrier system 200 discussed in connection with FIG. 3 above except as to fastening the first plate 205 to the second plate 210.

Again, the first and second plates 205, 210 may be positioned next to one another with the base portion 115 buried below ground 215 and the apertured portion 135 extending above ground 215. Additional plates (e.g., a third plate) can be installed similarly next to the first plate 205 and/or the second plate 210.

The environmental barrier system 300 further includes a fastener in the form of a fastening plate 305. The fastening plate 305 can be fastened to the first plate 205 and the second plate 210 and thereby serve to fasten the first plate 205 to the second plate 210. Although the fastening plate 305 is shown as fastened to the rear surface 110 of each of the plates 205, 210, in other examples the fastening plate 305 can be fastened to the front or side surface of each of the plates 205, 210.

In the example shown in FIG. 4, the fastening plate 305 includes a strap anchor 310. The strap anchor 310 in the illustrated example includes a pair of substantially aligned slots each extending through the body of the fastening plate 305 with a portion of the strap anchor's body located between the pair of slots. Embodiments of the fastening plate 305 can include a number of strap anchors 310 spaced from one another along a length of the fastening plate body, as in the illustrated example. To fasten the first plate 205 to the second plate 210, the strap anchor 310 can be aligned with a respective fastening aperture 150 of each of plates 205, 210 such that each slot of the strap anchor's pair of slots is aligned with the respective fastening aperture 150. In the present embodiment of the system 300, a strap 315 may be anchored to the strap anchor 310 of the fastening plate 305 on one side and extend through respective fastening apertures 150 of the plates 205, 210 on the opposite side. In this way, the fastening plate 305 can serve to fasten the first plate 205 to the second plate 210 while at the same time providing support at the interface of the first plate 205 and second plate 210. As a result, the fastening plate 305 may fasten the first plate 205 to the second plate 210 in a stabilized manner suited for applications where the plates 205, 210 may experience relatively large static and/or dynamic forces.

In addition to providing a more stabilized fastening of the plates 205, 210, the fastening plate 305 can be configured to avoid obstructing pathways through the apertures 145. In particular, the fastening plate 305 can be dimensioned, as shown in the example of FIG. 4, to have a width that extends some portion between an aperture 145 (e.g., fluid pathway aperture) nearest a side of plate 205 interfacing with plate 210 and an aperture 145 (e.g., fluid pathway aperture) nearest a side of plate 210 interfacing with plate 205. Such a configuration can include a width of the fastening plate 305 that is equal to or less than a total width of the space between an edge of the aperture 145 (e.g., fluid pathway aperture) nearest a side of plate 205 interfacing with plate 210 plus the space between an edge of the aperture 145 (e.g., fluid pathway aperture) nearest a side of plate 210 interfacing with plate 205. In such an embodiment, the fastening plate 305 can serve to fasten the first plate 205 to the second plate 210 without obstructing a pathway through one or more apertures 145. Accordingly, the stability of the environmental barrier system 300 can be improved through use of the fastening plate 305 without substantially reducing the functional efficiency of the environmental barrier system 300.

In some applications where the plates 205, 210 may be subjected to relatively large forces, support for the fastener (e.g., the fastening plate 305), and thus the interface of the fastened plates 205, 210, may be desirable. In these applications, embodiments of the environmental barrier system 300 can include a post 320. The post 320 is illustrated in FIG. 4 in a cutaway view so that other features present in this drawing can be seen. The post 320 may be installed such that a first portion of the post 320 is buried in ground 215 and a second portion of the post 320 extends substantially vertically up from ground 215. As shown, the installation location of the post 320 can be aligned with the interface location of the fastened plates 205, 210. The portion of the post 320 extending up from the ground 215 can contact the fastener (e.g., the fastening plate 305) to provide support to the fastener. Accordingly, the post 320 can act to provide counterforces to those imparted on an opposite side of the fastened plates 205, 210.

In an embodiment where an additional plate (e.g., a third plate) is installed similarly next to one of the plates 205, 210, an additional fastening plate (e.g., a second fastening plate) can be fastened to each of the two adjacent plates similar to that described above. Also, in such an embodiment an additional post (e.g., a second post) can be aligned with the interface location of the two adjacent plates and in contact with the fastener securing the two adjacent plates together.

Environmental barrier systems, such as the systems 200 and 300 disclosed herein, can further include a filter sheet similar to that shown and described with respect to FIGS. 1 and 2 above. In one such environmental barrier system embodiment, the filter sheet can be positioned in contact with the apertured portions, and in some cases at least a portion of the base portions, of each fastened plate in the system and extend up a distance from the ground. In the systems 200 and 300, the filter sheet, when included, could extend along each fastened plate in the system, for instance along the fastened plates 205, 210 including along the interface between these two plates. By positioning the filter sheet relative to the fastened plates as described, erosion can be controlled since the filter sheet can act to impede the passage of surface runoff entrained in fluid flow encountering the plates of the environmental barrier system. Yet, the respective apertured portions of the plates can allow fluid to pass through the environmental barrier system without building up in a manner that would create unsuitable hydrostatic forces on the environmental barrier system.

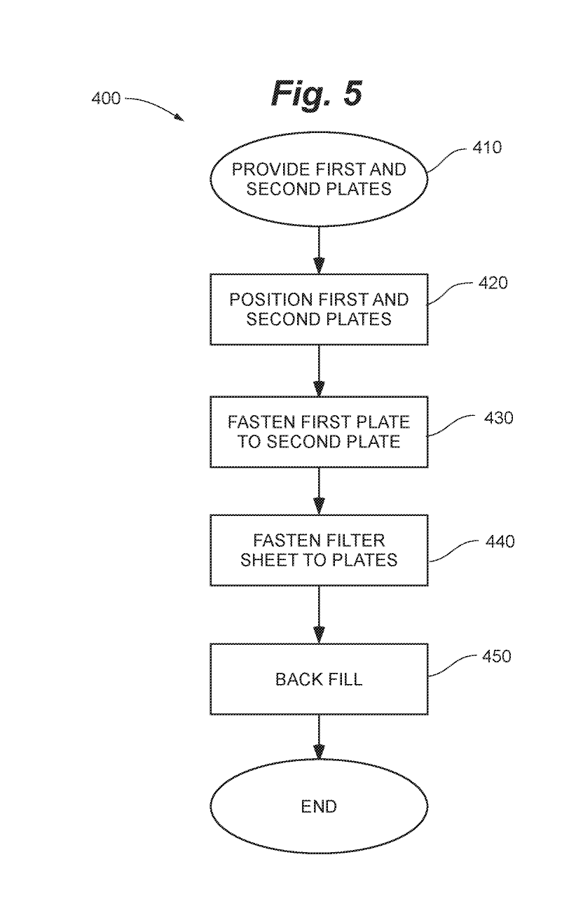

FIG. 5 illustrates a flow diagram of an embodiment of a method 400 for impeding a flow of water. In one example, the method 400 can include impeding the passage of surface runoff entrained in fluid flow with an environmental barrier system while allowing fluid of the fluid flow to substantially pass through the environmental barrier system.

At step 410, a first plate and a second plate are provided. Each of the first and second plate can be the same as, or similar to, any of the plate embodiments disclosed herein. For instance, each of the first and second plate can include one or more features of the front surface, the rear surface, the base portion, the apertured portion, and/or the drive head as disclosed herein. The provided first and second plates may be made of metal and/or other suitable material.

At step 420, the first and second plates are positioned next to one another. As one example, the base portion of each plate is buried below ground such that the apertured portion of each plate extends above the ground (e.g., substantially vertically). One way to position the first and second plate is to apply a downward force to respective drive heads of the first and second plates using a mechanical device. In one instance, this could include applying the downward force using a general purpose moving machine, such as a movable bucket of the general purpose moving machine. In a further example, the step of positioning the first and second plates next to one another can include a step of positioning a filter sheet at the ground and in contact with the respective apertured portions of the positioned first and second plates. The filter sheet can be positioned to span at least a length of the first and second plates.

At step 430, the first plate is fastened to the second plate by a fastener. As one example, the first plate can be fastened to the second plate by a fastener in the form of a fastening plate such as that disclosed herein. In another example, fastening the first plate to the second plate can include positioning a post to extend from the ground (e.g., substantially vertically) and be in contact with the fastener used for fastening the first and second plates.

Optionally, at step 440, a filter sheet is fastened to the first and second plates. The filter sheet can be secured to one or more apertures of the first and second plates and span a distance along, and in contact with, the front and/or back surfaces of the first and second plates.

Optionally, at step 450, ground can be backfilled against the filter sheet and first and second plates. In one example, the ground can be backfilled such that a portion of the first and second plates and a portion of the filter sheet are below the resulting ground surface after the backfill. This can be useful for further supporting the first and second plates and filter sheet in place.

Various examples have been described. These and other examples are within the scope of the following claims.

1. An environmental barrier system comprising:
a first plate and a second plate, each plate including a front surface, a rear surface, an apertured portion, and a base portion, the apertured portion having an apertured portion width and defining a plurality of apertures through the front and rear surfaces, and the base portion having a base portion width that tapers to become narrower than the apertured portion width, the first and second plates being configured to be positioned next to one another such that the base portions are buried below ground and the apertured portions extend above the ground substantially vertically; and
a fastener configured to fasten the first plate to the second plate.

2. The environmental barrier system of claim 1, wherein each plate's base portion includes a plurality of pointed segments on a lower edge of the base portion.

3. The environmental barrier system of claim 2, wherein each plate's apertured portion has an apertured portion thickness and each plate's base portion has a base portion thickness that tapers to become less than the apertured portion thickness.

4. The environmental barrier system of claim 1, wherein each plate's apertured portion has an apertured portion thickness, each plate further comprising a drive head adjacent an upper edge of the apertured portion, the drive head having a drive head thickness that is greater than the apertured portion thickness, each plate configured to be driven into the ground by a movable bucket of a general purpose moving machine applying downward force to the drive head.

5. The environmental barrier system of claim 1, wherein the fastener is configured to be inserted into one of the apertures of the first plate's plurality of apertures and into one of the apertures of the second plate's plurality of apertures to fasten the first plate to the second plate.

6. The environmental barrier system of claim 1, wherein the fastener comprises a first fastening plate configured to be fastened to the first plate and the second plate.

7. The environmental barrier system of claim 6, wherein each plate's apertured portion further defines a fastening aperture through the front and rear surfaces, the first fastening plate being configured to be fastened to the first plate and the second plate by their respective fastening apertures.

8. The environmental barrier system of claim 6, further comprising:
a third plate including a front surface, a rear surface, an apertured portion, and a base portion, the apertured portion having an apertured portion width and defining a plurality of apertures through the front and rear surfaces, and the base portion having a base portion width that tapers to become narrower than the apertured portion width, the third plate being configured to be positioned next to the second plate such that the base portions are buried below ground and the apertured portions extend substantially vertically; and
a second fastening plate configured to be fastened to the second plate and the third plate.

9. The environmental barrier system of claim 8, wherein each of the first and second fastening plates comprises a strap anchor, the environmental barrier system further comprising a strap configured to be anchored to the respective strap anchors of the first and second fastening plates.

10. The environmental barrier system of claim 1, further comprising a filter sheet configured to be positioned at the ground and in contact with the first and second plates' apertured portions.

11. The environmental barrier system of claim 1, further comprising a post configured to extend substantially vertically from the ground and contact the fastener to provide support for the fastener.

12. A method of impeding a flow of water, comprising:
providing a first plate and a second plate, each plate including a front surface, a rear surface, an apertured portion, and a base portion, the apertured portion having an apertured portion width and defining a plurality of apertures through the front and rear surfaces, and the base portion having a base portion width that tapers to become narrower than the apertured portion width;
positioning the first and second plates next to one another by burying the base portions of the first and second plates below ground such that the apertured portions extend above the ground substantially vertically; and
fastening the first plate to the second plate with a fastener.

13. The method of claim 12, wherein each plate's base portion includes a plurality of pointed segments on a lower edge of the base portion.

14. The method of claim 13, wherein each plate's apertured portion has an apertured portion thickness and each plate's base portion has a base portion thickness that tapers to become less than the apertured portion thickness.

15. The method of claim 12, wherein each plate's apertured portion has an apertured portion thickness, each plate further comprising a drive head adjacent an upper edge of the apertured portion, the drive head having a drive head thickness that is greater than the apertured portion thickness, and wherein burying the base portions of the first and second plates below ground comprises driving the first and second plates into the ground by a movable bucket of a general purpose moving machine applying downward force to the drive head.

16. The method of claim 12, wherein the fastener comprises a first fastening plate, and fastening the first plate to the second plate comprises fastening the first fastening plate to the first plate and the second plate.

17. The method of claim 16, wherein each plate's apertured portion further defines a fastening aperture through the front and rear surfaces, and fastening the first plate to the second plate comprises fastening the first fastening plate to the first plate and the second plate by their respective fastening apertures.

18. The method of claim 16, further comprising:
providing a third plate including a front surface, a rear surface, an apertured portion, and a base portion, the apertured portion having an apertured portion width and defining a plurality of apertures through the front and rear surfaces, and the base portion having a base portion width that tapers to become narrower than the apertured portion width;
positioning the third plate next to the second plate by burying the base portion of the third plate below ground such that the apertured portion extends above the ground substantially vertically; and
fastening a second fastening plate to the second plate and the third plate.

19. The method of claim 18, wherein each of the first and second fastening plates comprises a strap anchor, the method further comprising anchoring a strap to the respective strap anchors of the first and second fastening plates.

20. The method of claim 12, further comprising positioning a filter sheet at the ground and in contact with the first and second plates' apertured portions.
